(19) United States
(12) Patent Application Publication
(10) Pub. No.: US 2015/0376406 A1
(43) Pub. Date: Dec. 31, 2015

(54) Benzoxazine Curable Composition Containing Polysulfone-Based Tougheners

(71) Applicant: Huntsman Advanced Materials Americas LLC, The Woodlands, TX (US)

(72) Inventors: Dong Wang, The Woodlands, TX (US); Nicholas Williams, Houston, TX (US); Derek Kincaid, Spring, TX (US)

(73) Assignee: Huuntsman Advance Materials Americas LLC, The Woodlands, TX (US)

(21) Appl. No.: 14/765,590

(22) PCT Filed: Feb. 27, 2014
(86) PCT No.: PCT/US14/18859

§ 371 Date: Aug. 4, 2015

Related U.S. Application Data
(60) Provisional application No. 61/772,001, filed on Mar. 4, 2013.

(51) Int. Cl. C08L 79/04; C09J 11/06; C09D 7/12; C09J 179/04; C09D 179/04

(52) U.S. Cl. CPC C08L 79/04; C09J 179/04; C09D 179/04; C09D 7/1233; C09J 11/06

(57) ABSTRACT

The present disclosure provides a curable composition containing a benzoxazine and a polysulfone-based toughener. The curable composition, upon curing, renders a cured article having well balanced thermal, chemical and mechanical properties, The curable composition may be used in a variety of applications, such as in coatings, structural composites and encapsulating systems for electronic and electrical components.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF INVENTION

This disclosure relates to a curable composition containing a benzoxazine and a polysulfone-based toughener. The curable composition, upon curing, exhibits excellent toughness, high glass transition temperature and flexural and tensile modulus and is therefore useful in a variety of applications, including but not limited to, for use in producing composite articles in resin transfer molding, vacuum assisted resin transfer molding and resin film infusion processes.

### BACKGROUND OF THE INVENTION

Polymers derived from the ring opening polymerization of benzoxazines compete with phenolic, epoxy and other thermoset or thermoplastic resins in various applications, such as in prepregs, laminates, PWB's, molding compounds, sealants, sinter powders, cast articles, structural composites and electrical components. The benzoxazines, which are synthesized by the reaction of a phenol with an amine and an aldehyde in the presence or absence of a solvent, have been shown to be, upon curing, dimensionally stable with good electrical and mechanical resistance, low shrinkage, low water absorption with medium to high glass transition temperatures; however, they also tend to be inherently brittle.

Benzoxazines have also been combined with various epoxy resins to produce curable compositions (see, for e.g. U.S. Pat. No. 4,607,091 (Schreiber), 5,021,484 (Schreiber), 5,200,452 (Schreiber) and 5,443,911 (Schreiber)). Because the epoxy resin reduces the melt viscosity of the benzoxazine, these blends have been shown to be useful in electrical applications since the blend is able to handle higher filler loadings, yet still maintain a processable viscosity. One drawback to the use of such blends however is that higher curing temperatures are usually necessary because of the addition of the epoxy. Furthermore, although these blends exhibit high glass transition temperatures after curing, toughness and stiffness are usually sacrificed to some degree.

More recently, tougheners have been added in order to improve flexibility. For example, WO 2010/031826 and WO 2007/075743 disclose curable compositions that contain a benzoxazine compound and a phenol (preferably bisphenol A) end-capped prepolymer toughener; EP 1639038 discloses a curable composition containing a benzoxazine and an acrylonitrile-butadiene copolymer toughener; WO 2009/075746 teaches curable compositions that include a benzoxazine and a benzoxazine macromonomer toughener containing at least 3 benzoxazine rings and at least one aliphatic, heteroaliphatic, araliphatic, heteroaralaliphatic, aromatic or heteroaromatic soft fragment; WO 2009/075744 teaches the use of benzoxazine-based and non-benzoxazine-based toughening additives for a benzoxazine matrix resin component; WO 2007/064801 discloses a composition that contains a benzoxazine and a combination of two adduct tougheners: the first being prepared from hydroxy-containing compounds, isocyanate-containing compounds and a phenolic compound; and, the second being prepared from the first adduct and an epoxy-containing compound and a second phenolic compound; WO 2012/015604 discloses a benzoxazine component and a phenol-terminated polyurethane, polyurea or a polyurea-urethane; and, WO 2012/100980 teaches a composition that includes a benzoxazine component, an arylsulphone-containing benzoxazine component and a polyethersulfone so that a homogeneous miscible blend could be obtained.

Notwithstanding the state of the technology, it is an object of the present disclosure to provide an improved benzoxazine-based composition containing a toughening agent which is compatible with the benzoxazine compound, and upon cure, is able to perform thermally, mechanically and physically at high temperatures for long periods of time without sacrificing glass transition temperature and modulus properties, therefore making it useful in high temperature applications within various industries, such as in the aerospace, electronic and automotive industries.

### SUMMARY OF THE INVENTION

The present disclosure provides a curable composition that includes a benzoxazine and a polysulfone-based toughener. In one embodiment, the curable composition, upon curing, provides an article having an excellent toughness and a high glass transition temperature, as well as high modulus properties.

The curable composition according to the present disclosure is useful in a variety of applications including as a coating, adhesive, sealant, or as a matrice for the preparation of a structural composite.

### DETAILED DESCRIPTION OF THE INVENTION

If appearing herein, the term “Comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical objects of the article. By way of example, “a benzoxazine” means one benzoxazine or more than one benzoxazine. The phrases “in one embodiment,” “according to one embodiment,” and the like generally mean the particular feature, structure, or characteristic following the phrase is included in at least one embodiment of the present invention, and may be included in more than one embodiment of the present disclosure. Importantly, such phrases do not necessarily refer to the same embodiment. If the specification states a component or feature “may”, “can”, “could”, or “might” be included or have a characteristic, that particular component or feature is not required to be included or have the characteristic.

It shall also be understood that the expression “ambient temperature” if used herein is to mean the temperature of the surrounding work environment (e.g. the temperature of the area, building or room where the curable composition is used), exclusive of any temperature changes that occur as a result of the direct application of heat to the curable composition to facilitate curing. The ambient temperature is typically between about 10° C. and about 30° C.

According to one embodiment, the curable composition contains a benzoxazine. The benzoxazine, which imparts mechanical strength, low water absorption and thermal curability to the curable composition, may be any curable monomer, oligomer or polymer containing at least one benzoxazine moiety.

Thus, in one embodiment, the benzoxazine may be represented by the general formula

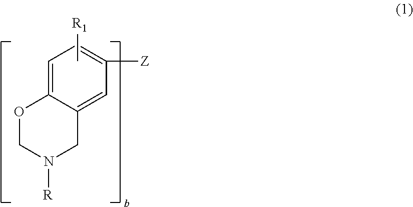

where b is an integer from 1 to 4; each R is independently hydrogen, a substituted or unsubstituted C₁-C₂₀ alkyl group, a substituted or unsubstituted C₂-C₂₀ alkenyl group, a substituted or unsubstituted C₆-C₂₀ aryl group, a substituted or unsubstituted C₂-C₂₀ heteroaryl group, a substituted or unsubstituted C₄-C₂₀ carbocyclic group, a substituted or unsubstituted C₂-C₂₀ heterocyclic group, or a C₃-C₈ cycloalkyl group; each R₁ is independently hydrogen, a C₁-C₂₀ alkyl group, a C₂-C₂₀ alkenyl group, or a C₆-C₂₀ aryl group; and Z is a direct bond (when b=2), a substituted or unsubstituted C₁-C₂₀ alkyl group, a substituted or unsubstituted C₆-C₂₀ aryl group, a substituted or unsubstituted C₂-C₂₀ heteroaryl group, O, S, S═O, O═S═O or C═O. Substituents include, but are not limited to, hydroxy, a C₁-C₂₀ alkyl group, a C₂-C₁₀ alkoxy group, mercapto, a C₃-C₈ cycloalkyl group, a C₆-C₁₄ heterocyclic group, a C₆-C₁₄ aryl group, a C₆-C₁₄ heteroaryl group, halogen, cyano, nitro, nitrone, amino, amido, acyl, oxyacyl, carboxyl, carbamate, sulfonyl, sulfonamide, and sulfuryl.

In a particular embodiment within formula (1), the benzoxazine may be represented by the following formula:

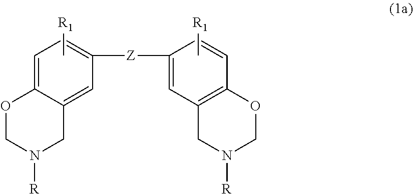

where Z is selected from a direct bond, CH₂, C(CH₃)₂, C═O, O, S, S═O, O═S═O and

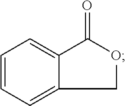

each R is independently hydrogen, a C₁-C₂₀ alkyl group, an allyl group, or a C₆-C₁₄ aryl group; and R₁ is defined as above.

In another embodiment, the benzoxazine may be embraced by the following general formula

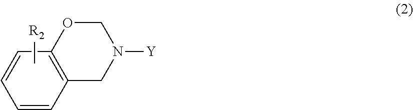

where Y is a C₁-C₂₀ alkyl group, a C₂-C₂₀ alkenyl group, or substituted or unsubstituted phenyl; and each R₂ is independently hydrogen, halogen, a C₁-C₂₀ alkyl group, a C₂-C₂₀ alkenyl group or a C₆-C₂₀ aryl group. Suitable substituents for phenyl are as set forth above.

In a particular embodiment within formula (2), the benzoxazine may be represented by the following formula

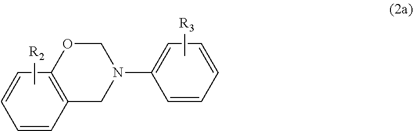

where each R₂ is independently a C₁-C₂₀ alkyl or C₂-C₂₀ alkenyl group, each of which being optionally substituted or interrupted by one or more O, N, S, C═O, COO and NHC═O, and a C₆-C₂₀ aryl group; and each R₃ is independently hydrogen, a C₁-C₂₀ alkyl or C₂-C₂₀ alkenyl group, each of which being optionally substituted or interrupted by one or more O, N, S, C═O, COOH and NHC═O or a C₆-C₂₀ aryl group.

Alternatively, the benzoxazine may be embraced by the following general formula

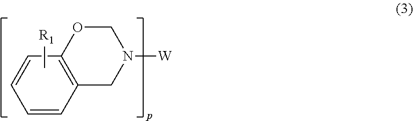

where p is 2; W is selected from biphenyl, diphenyl methane, diphenyl isopropane, diphenyl sulfide, diphenyl sulfoxide, diphenyl sulfone, and diphenyl ketone; and R¹ is defined as above.

In the present disclosure, combinations of multifunctional benzoxazines and monofunctional benzoxazines, or combinations of one or more multifunctional benzoxazines and one or more monofunctional benzoxazines may be used.

The benzoxazines are commercially available from several sources including Huntsman Advanced Materials Americas LLC, Georgia Pacific Resins Inc. and Shikoku Chemicals Corporation.

The benzoxazines may also be obtained by reacting a phenol compound, for example, bisphenol A, bisphenol F or phenolphthalein, with an aldehyde, for example, formaldehyde, and a primary amine, under conditions in which water is removed. The molar ratio of phenol compound to aldehyde reactant may be from about 1:3 to 1:10, alternatively from about 1:4: to 1:7. In still another embodiment, the molar ratio of phenol compound to aldehyde reactant may be from about 1:4.5 to 1:5. The molar ratio of phenol compound to primary amine reactant may be from about 1:1 to 1:3, alternatively from about 1:1.4 to 1:2.5. In still another embodiment, the molar ratio of phenol compound to primary amine reactant may be from about 1:2.1 to 1:2.2.

Examples of primary amines include: aromatic mono- or di-amines, aliphatic amines, cycloaliphatic amines and heterocyclic monoamines, for example, aniline, o-, m- and p-phenylene diamine, benzidine, 4,4′-diaminodiphenyl methane, cyclohexylamine, butylamine, methylamine, hexylamine, allylamine, furfurylamine ethylenediamine, and propylenediamine. The amines may, in their respective carbon part, be substituted by C₁-C₈ alkyl or allyl. In one embodiment, the primary amine is a compound having the general formula RₐNH₂, wherein Rₐ is allyl, unsubstituted or substituted phenyl, unsubstituted or substituted C₁-C₈ alkyl or unsubstituted or substituted C₃-C₈ cycloalkyl. Suitable substituents on the Rₐ group include, but are not limited to, amino, C₁-C₄ alkyl and allyl. In some embodiments, one to four substituents may be present on the Rₐ group. In one particular embodiment, Rₐ is phenyl.

According to one embodiment, the benzoxazine may be included in the curable composition in an amount in the range of between about 10% to about 90% by weight, based on the total weight of the curable composition. In another embodiment, the benzoxazine may be included in the curable composition in an amount in the range of between about 25% to about 75% by weight, based on the total weight of the curable composition.

The curable composition also contains a polysulfone-based toughener. In one embodiment, the polysulfone-based toughener is a compound comprising one or more repeating units of the formula (4):

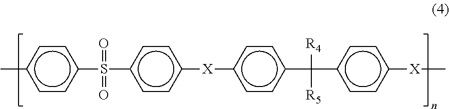

where n=1 to 2 and can be fractional;
X is O or S, preferably O, and may differ from unit to unit; and
R₄ and R₅ are independently H, a C₁ to C₈ alkyl group or are fused together,

According to another embodiment, the compound containing one or more repeating units of the formula (4) may further comprise one or more reactive end groups. In one embodiment, the compound containing one or more repeating units of the formula (4) comprises two reactive end groups. In yet another embodiment, the compound containing one or more repeating units of the formula (4) comprises one reactive end group. The reactive end groups may be obtained by a reaction of monomers or by subsequent conversion of product polymers prior to, or subsequent to, isolation. In one embodiment, the reactive end groups are groups providing an active hydrogen, for example, —OH, —COOH, —NH₂, —NHR^{k} or —SH, where R^{k} is a hydrocarbon group containing up to eight carbon atoms. In another embodiment, the reactive end groups are groups providing other cross-linking activity, for example, benzoxazine, epoxy, (meth)acrylate, cyanate, isocyanate, acetylene or ethylene, as in vinyl or allyl, maleimide, or anhydride.

In another embodiment, the polysulfone-based toughener is a homopolymer compound containing one or more repeating units of the formula (4) and which may optionally further comprise one or more reactive end groups. In another embodiment, the polysulfone-based toughener is a copolymer compound containing one or more repeating units of the formula (4) and one or more other repeating units incorporated into the main chain or as a side group to further adjust the toughener's properties and may further comprise one or more reactive end groups. Examples of other repeating units include, but are not limited to:

—X—Ar—SO₂—Ar—X—Ar—SO₂—Ar— (referred to herein as a “PES unit”)

and

—X—(Ar)ₐ—X—Ar—SO₂—Ar— (referred to herein as a “PEES unit”)

where X is O or S, preferably O, and may differ from unit to unit;
Ar is phenylene; and
a=1 to 3 and can be fractional and wherein when a is greater than 1, the phenylene groups are linked linearly through a single chemical bond.

By “fractional” reference is made to the average value for a given polymer chain containing units having various values of n and a.

In yet another embodiment, the polysulfone-based toughener homopolymer or copolymer compound has a number average molecular weight within the range of about 1500 to about 60,000. In another embodiment, the polysulfone-based toughener homopolymer or copolymer compound has a number average molecular weight within the range of about 2000 to about 30,000.

According to yet another embodiment, the polysulfone-based homopolymer or copolymer compound is included in the curable composition in an amount within the range of about 2% to about 50% by weight, based on the total weight of the curable composition. In another embodiment, the polysulfone-based homopolymer or copolymer compound is included in the curable composition in an amount within the range of about 15% to about 40% by weight, based on the total weight of the curable composition.

It has been surprisingly found that, compared to traditional polyethersulfone homopolymer tougheners such as PES 5003P, commercially available from Sumitomo Chemical Company, or RADEL® toughener, commercially available from Solvay Advanced Polymers, LLC, the toughener compounds above containing one or more repeating units of the formula (4) exhibit significantly improved compatibility and solubility when combined with the benzoxazine. Moreover, the curable composition containing the benzoxazine and toughener compounds above exhibits unexpectedly high toughness while retaining other benzoxazine critical properties including high glass transition temperatures and high modulus.

The curable composition may optionally contain an epoxy resin. The epoxy resin may be any compound having an oxirane ring. In general, any oxirane ring-containing compound is suitable for use as the epoxy resin in the present disclosure, such as the epoxy compounds disclosed in U.S. Pat. No. 5,476,748 which is incorporated herein by reference. The epoxy resin may be solid or liquid. In one embodiment, the epoxy resin is selected from a polyglycidyl epoxy compound; a non-glycidyl epoxy compound; an epoxy cresol novolac compound; an epoxy phenol novolac compound and mixtures thereof.

The polyglycidyl epoxy compound may be a polyglycidyl ether, poly(β-methylglycidyl) ether, polyglycidyl ester or poly(β-methylglycidyl) ester. The synthesis and examples of polyglycidyl ethers, poly(β-methylglycidyl) ethers, polyglycidyl esters and poly(β-methylglycidyl) esters are disclosed in U.S. Pat. No. 5,972,563, which is incorporated herein by reference. For example, ethers may be obtained by reacting a compound having at least one free alcoholic hydroxyl group and/or phenolic hydroxyl group with a suitably substituted epichlorohydrin under alkaline conditions or in the presence of an acidic catalyst followed by alkali treatment. The alcohols may be, for example, acyclic alcohols, such as ethylene glycol, diethylene glycol and higher poly(oxyethylene) glycols, propane-1,2-diol, or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol and sorbitol. Suitable glycidyl ethers may also be obtained, however, from cycloaliphatic alcohols, such as 1,3- or 1,4-dihydroxycyclohexane, bis(4-hydroxycyclo-hexyl)methane, 2,2-bis(4-hydroxycyclohexyl)propane or 1,1-bis(hydroxymethyl)cyclohex-3-ene, or they may possess aromatic rings, such as N,N-bis(2-hydroxyethyl)aniline or p,p′-bis(2-hydroxyethylamino)diphenylmethane.

Particularly important representatives of polyglycidyl ethers or poly(β-methylglycidyl)ethers are based on monocyclic phenols, for example, on resorcinol or hydroquinone, on polycyclic phenols, for example, on bis(4-hydroxyphenyl)methane (Bisphenol F), 2,2-bis(4-hydroxyphenyl)propane (Bisphenol A), bis(4-hydroxyphenyl)sulfone (Bisphenol S), alkoxylated Bisphenol A, F or S, triol extended Bisphenol A, F or S, brominated Bisphenol A, F or S, hydrogenated Bisphenol A, F or S, glycidyl ethers of phenols and phenols with pendant groups or chains, on condensation products, obtained under acidic conditions, of phenols or cresols with formaldehyde, such as phenol novolaks and cresol novolaks, or on siloxane diglycidyls.

Polyglycidyl esters and poly(P-methylglycidyl)esters may be produced by reacting epichlorohydrin or glycerol dichlorohydrin or β-methylepichlorohydrin with a polycarboxylic acid compound. The reaction is expediently carried out in the presence of bases. The polycarboxylic acid compounds may be, for example, glutaric acid, adipic acid, pimelic acid, suberic acid, azelaic acid, sebacic acid or dimerized or trimerized linoleic acid. Likewise, however, it is also possible to employ cycloaliphatic polycarboxylic acids, for example tetrahydrophthalic acid, 4-methyltetrahydrophthalic acid, hexahydrophthalic acid or 4-methylhexahydrophthalic acid. It is also possible to use aromatic polycarboxylic acids such as, for example, phthalic acid, isophthalic acid, trimellitic acid or pyromellitic acid, or else carboxyl-terminated adducts, for example of trimellitic acid and polyols, for example glycerol or 2,2-bis(4-hydroxycyclohexyl)propane, may be used.

In another embodiment, the epoxy resin is a non-glycidyl epoxy compound. Non-glycidyl epoxy compounds may be linear, branched, or cyclic in structure. For example, there may be included one or more epoxide compounds in which the epoxide groups form part of an alicyclic or heterocyclic ring system. Others include an epoxy-containing compound with at least one epoxycyclohexyl group that is bonded directly or indirectly to a group containing at least one silicon atom. Examples are disclosed in U.S. Pat. No. 5,639,413, which is incorporated herein by reference. Still others include epoxides which contain one or more cyclohexane oxide groups and epoxides which contain one or more cyclopentene oxide groups.

Particularly suitable non-glycidyl epoxy compound's include the following difunctional non-glycidyl epoxide compounds in which the epoxide groups form part of an alicyclic or heterocyclic ring system: bis(2,3-epoxycyclopentyl)ether, 1,2-bis(2,3-epoxycyclopentyloxy)ethane, 3,4-epoxycyclohexyl-methyl 3,4-epoxycyclohexanecarboxylate, 3,4-epoxy-6-methyl-cyclohexylmethyl 3,4-epoxy-6-methylcyclohexaneearboxylate, di(3,4-epoxycyclohexylmethyl)hexanedioate, di(3,4-epoxy-6-methylcyclohexylmethyl) hexanedioate, ethylenebis(3,4-epoxycyclohexanecarboxylate), ethanediol di(3,4-epoxycyclohexylmethyl.

Highly preferred difunctional non-glycidyl epoxies include cycloaliphatic difunctional non-glycidyl epoxies, such as 3,4-epoxycyclohexyl-methyl 3′,4′-epoxycyclohexanecarboxylate and 2,2′-bis-(3,4-epoxy-cyclohexyl)-propane, with the former being most preferred.

In another embodiment, the epoxy resin is a poly(N-glycidyl) compound or poly(S-glycidyl) compound. Poly(N-glycidyl) compounds are obtainable, for example, by dehydrochlorination of the reaction products of epichlorohydrin with amines containing at least two amine hydrogen atoms. These amines may be, for example, n-butylamine, aniline, toluidine, m-xylylenediamine, bis(4-aminophenyl)methane or bis(4-methylaminophenyl)methane. Other examples of poly(N-glycidyl) compounds include N,N′-diglycidyl derivatives of cycloalkyleneureas, such as ethyleneurea or 1,3-propyleneurea, and N,N′-diglycidyl derivatives of hydantoins, such as of 5,5-dimethylhydantoin. Examples of poly(S-glycidyl) compounds are di-S-glycidyl derivatives derived from dithiols, for example ethane-1,2-dithiol or bis(4-mercaptomethylphenyl)ether.

It is also possible to employ epoxy resins in which the 1,2-epoxide groups are attached to different heteroatoms or functional groups. Examples include the N,N,O-triglycidyl derivative of 4-aminophenol, the glycidyl ether/glycidyl ester of salicylic acid, N-glycidyl-N′-(2-glycidyloxypropyl)-5,5-dimethylhydantoin or 2-glycidyloxy-1,3-bis(5,5-dimethyl-1-glycidylhydantoin-3-yl)propane.

Other epoxide derivatives may also be employed, such as vinyl cyclohexene dioxide, limonene dioxide, limonene monoxide, vinyl cyclohexene monoxide, 3,4-epoxycyclohexlmethyl acrylate, 3,4-epoxy-6-methyl cyclohexylmethyl 9,10-epoxystearate, and 1,2-bis(2,3-epoxy-2-methylpropoxy)ethane.

Additionally, the epoxy resin may be a pre-reacted adduct of an epoxy resin, such as those mentioned above, with known hardeners for epoxy resins.

According to one embodiment, the epoxy resin may be included in the curable composition in an amount in the range of between about 10% to about 70% by weight, based on the total weight of the curable composition. In another embodiment, the epoxy resin may be included in the curable composition in an amount in the range of between about 15% to about 60% by weight, based on the total weight of the phenolic-free composition.

In another embodiment, the curable composition may optionally contain one or more additives. Examples of such additives, include, but are not limited to, a toughening agent, catalyst, reinforcing agent, filler and mixtures thereof.

Examples of toughening agents which may be used include copolymers based on butadiene/acrylonitrile, butadiene/(meth)acrylic acid esters, butadiene/acrylonitrile/styrene graft copolymers (“ABS”), butadiene/methyl methacrylate/styrene graft copolymers (“MBS”), poly(propylene) oxides, amine-terminated butadiene/acrylonitrile copolymers (“ATBN”), rubber particles having a core-shell structure in an epoxy resin matrix such as MX-120 resin from Kaneka Corporation, and rubber-modified epoxy resin, for instance an epoxy-terminated adduct of an epoxy resin and a diene rubber or a conjugated diene/nitrile rubber.

Examples of catalysts which may be used include polyphenols, phenolic resins, amine compounds, polyaminoamides, imidazoles, phosphines, and metal complexes of organic sulfur containing acid as described in WO 200915488, which is incorporated herein by reference.

Examples of filler and reinforcing agents which may be used include silica, silica nanoparticles pre-dispersed in epoxy resins, such as those available under the tradename NANOPDX from Nanoresins, coal tar, bitumen, textile fibres, glass fibres, asbestos fibres, boron fibres, carbon fibres, mineral silicates, mica, powdered quartz, hydrated aluminum oxide, bentonite, wollastonite, kaolin, aerogel or metal powders, for example aluminium powder or iron powder, and also pigments and dyes, such as carbon black, oxide colors and titanium dioxide, light weight microballoons, such cenospheres, glass microspheres, carbon and polymer microballoons, fire-retarding agents, thixotropic agents, flow control agents, such as silicones, waxes and stearates, which can, in part, also be used as mold release agents, adhesion promoters, antioxidants and light stabilizers, the particle size and distribution of many of which may be controlled to vary the physical properties and performance of the inventive compositions.

If present, the additive may be include in the curable composition in an amount in the range of between about 0.1% to about 30% by weight, based on the total weight of the curable composition. In further embodiments, the additive may be added to the curable composition in an amount in the range of between about 2% to about 20% by weight, preferably between about 5% to about 15% by weight, based on the total weight of the curable composition.

The curable composition of the present disclosure can be prepared in known manner, for example, by premixing individual components and then mixing these premixes, or by mixing all of the components together using customary devices, such as a stirred vessel, stirring rod, ball mill, sample mixer, static mixer, high shear mixer, ribbon blender or by hot melting. To facilitate the dissolving of the polysulfone-based toughener within the curable composition, in one embodiment, the toughener can be pre-blended with the epoxy resin at an elevated temperature, such as up to about 180° C., allowing for the end groups to partially or fully react with the epoxy resin which can further increase the compatibility/adhesion between the toughener and matrix resin phases. A solvent may also be added to the mixture to aid in preparing the curable composition. The solvent and amount thereof can be chosen so that the mixture of the components forms at least a stable apparently single-phase solution. Once mixed, the solvent may be removed from the curable composition by evaporation. However, in some embodiments, it's preferred that the curable composition contain up to 5% by weight solvent (wherein the % by weight is based on the total weight of the curable composition) to assist in flow when the curable composition is used to impregnate fibers. This residual amount of solvent can then be removed from the composition once it comes into contact with the rollers of the impregnating machine. After the curable composition of the present disclosure has been formulated, it may be packaged in a variety of containers such as steel, tin, aluminium, plastic, glass or cardboard containers.

Thus, according to another embodiment, the curable composition of the present disclosure is prepared by mixing together from about 10-90% by weight of the benzoxazine and from about 2-50% by weight of the polysulfone-based toughener, wherein the % by weight is based on the total weight of the curable composition. In another embodiment, the curable composition is prepared by mixing together from about 10-90% by weight of the benzoxazine, from about 2-50% by weight of the polysulfone-based toughener and from about 10-70% by weight of an epoxy resin, wherein the % by weight is based on the total weight of the curable composition.

The formulated curable composition may then be applied to an article or substrate and cured at a temperature up to about 240° C., for example a temperature within the range of 160°-220° C., and in some embodiments at elevated pressure, to form a cured article. In other embodiments, curing can be carried out in one or two or more stages, the first curing stage being carried out at a lower temperature and the post-curing at a higher temperature(s). In one embodiment, curing may be carried out in one or more stages at a temperature within the range of about 150°-230° C.

The curable composition is particularly suitable for use as a coating, adhesive, sealant, and matrice for the preparation of reinforced composite material, such as prepregs and towpegs, and can also be used in injection molding or extrusion processes.

Thus, in another embodiment, the present disclosure provides an adhesive, sealant, coating or encapsulating system for electronic or electrical components comprising the curable composition of the present disclosure. Suitable substrates on which the coating, sealant, adhesive or encapsulating system comprising the curable composition may be applied include metal, such as steel, aluminum, titanium, magnesium, brass, stainless steel, galvanized steel; silicates such as glass and quartz; metal oxides; concrete; wood; electronic chip material, such as semiconductor chip material; or polymers, such as polyimide film and polycarbonate. The adhesive, sealant or coating comprising the curable composition may be used in a variety of applications, such as in industrial or electronic applications.

In another embodiment, the present disclosure is also applicable to the manufacture of composite articles by conventional prepreg and towpreg technology and also by resin infusion technology as described in, for example, US 2004/0041128, the contents of which are incorporated herein by reference. Resin infusion is a generic term and encompasses processing techniques such as Resin Transfer Molding (RTM), Liquid Resin Infusion (LRI), Vacuum Assisted Resin Transfer Molding (VaRTM), Resin Infusion with Flexible Tooling (RIFT), Vacuum Assisted Resin Infusion (VARI), Resin Film Infusion (RFI), Controlled Atmospheric Pressure Resin Infusion (CAPRI), Vacuum Assisted Process (VAP), and Single Line Injection (SLI).

The properties of the composite articles can be tailored for certain applications by the addition of reinforcement fibers. Examples of reinforcement fibers include glass, quartz, carbon, alumina, ceramic, metallic, aramid, natural fibers (e.g. flax, jute, sisal, hemp), paper, acrylic and polyethylene fibers and mixtures thereof. The reinforcement fibers may be in any of various modes, for example, as a strand or roving formed by paralleling continuous fibers or discontinuous fibers (short fibers) in one direction, cloth such as woven fabric or mat, braids, unidirectional, bi-directional, random, pseudo-isotropic or three-dimensionally dispersed mat-like material, heterogeneous lattice or mesh material, and three-dimensional material such as triaxially woven fabric.

According to one embodiment, there is provided a method for producing a composite article in a resin transfer molding system. The process includes the steps of: a) introducing a fiber preform comprising reinforcement fibers into a mould; b) injecting the curable composition of the present disclosure into the mould, c) allowing the curable composition to impregnate the fiber preform; and d) heating the resin impregnated preform at a temperature of least about 90° C., preferably at least about 90° C. to about 200° C. for a sufficient period of time to produce an at least partially cured solid article; and e) optionally subjecting the partially cured solid article to post curing operations to produce the composite article.

In an alternative embodiment, the present disclosure provides a method for producing a composite article in a vacuum assisted resin transfer molding system. The process includes the steps of a) introducing a fiber preform comprising reinforcement fibers into a mould; b) injecting the curable composition of the present disclosure into the mold; c) reducing the pressure within the mold; d) maintaining the mold at about the reduced pressure; e) allowing the curable composition to impregnate the fiber preform; and f) heating the resin impregnated preform at a temperature of at least about 90° C., preferably at least about 90° C. to about 200° C. for a sufficient period of time to produce an at least partially cured solid article; and e) optionally subjecting the at least partially cured solid article to post curing operations to produce the flame retarded composite article.

Thus in another embodiment there is provided a cured article comprising bundles or layers of fibers infused with the curable composition of the present disclosure.

In still another aspect, the curable composition, upon mixing and curing, provides a cured article, for example a laminate, with excellent well-balanced properties. The properties of the cured product that are well-balanced in accordance with the present disclosure include at least three of: a glass transition temperature (Tg) of greater than about 170° C., preferably greater than about 175° C., and more preferably greater than about 180° C.; a flexural modulus or tensile modulus of greater than about 3.9 Gpa, preferably greater than about 4 Gpa; a flexural strength of greater than about 90 Mpa, preferably greater than about 95 Mpa, and more preferably greater than about 99 Mpa; and a tensile strength of greater than about 45 Mpa, preferably greater than about 50 Mpa, and even more preferably greater than about 55 Mpa.

### EXAMPLES

### Example 1

Into a 500 mL flask equipped with a mechanical stirrer and a reflux condenser were charged 23 parts weight of CY179 epoxy resin (available from Huntsman Corporation) and 10 parts weight of a hydroxy-terminated polyethersulfone homopolymer, Sumikaexcal 5003p PES (available from Sumitomo Chemical Company). The flask containing the mixed solution was then heated to a temperature of about 150° C. and the polyethersulfone did not dissolve in the epoxy resin. The temperature was then further increased to about 170° C., however, the polyethersulfone still did not dissolve in the epoxy resin.

### Example 2

Into a 1 L flask equipped with a mechanical stirrer and a reflux condenser were charged 33 parts weight of CY179 epoxy resin and 15 parts weight of a hydroxy-terminated polyethersulfone homopolymer, VW10700RFP (available from Solvay Advanced Polymers) having a number average molecular weight of 22,000. The flask containing the mixed solution was then heated to a temperature of about 150° C. under full vacuum and, within about 1 hour, the polyethersulfone and epoxy resin formed a homogenous solution. Once the solution became clear, the temperature was lowered to about 120° C. and 100 parts weight bisphenol A benzoxazine resin was added to form a composition. Further casting was tried by pouring the composition into a pre-heated mould and curing the composition at a temperature of about 180° C. for about 2 hours, then at a temperature of about 200° C. for about 2 hours and then further at a temperature of about 220° C. for about 2 hours. The cured plaque exhibited gross phase with a toughening phase settled out at the bottom of the plaque.

### Example 3

Into a 1 L flask equipped with a mechanical stirrer and reflux condenser were charged 33 parts weight of CY179 epoxy resin and 15 parts weight of an amine-terminated polysulfone, VW30500 (available from Solvay Advanced Polymers), having a number average molecular weight=14,000. The flask containing the mixed solution was then heated to a temperature of about 150° C. and maintained at that temperature for about 1 hour to allow the amine end groups on the polysulfone to react with the epoxy. The temperature was then lowered to about 120° C. and 100 parts weight of bisphenol A benzoxazine were added to the mixture and vacuum was then applied. The mixture, upon becoming clear and bubble-free, was then poured into a pre-heated mould and cured at the conditions listed in Table 1. After curing, a clear plaque was obtained indicating excellent compatibility between the toughener phase and matrix phase. Related thermal and mechanical properties are shown below in Table 1.

### Example 4

Into a 1 L flask equipped with a mechanical stirrer and reflux condenser were charged 43 parts weight of CY179 epoxy resin and 36 parts weight of an amine-terminated polysulfone, VW30500. The flask containing the mixed solution was then heated to a temperature of about 150° C. and maintained at that temperature for about 1 hour to allow the amine end groups on the polysulfone to react with the epoxy. The temperature was then lowered to about 120° C. and 100 parts weight of bisphenol A benzoxazine were added to the mixture and vacuum was then applied. The mixture, upon becoming clear and bubble-free, was then poured into a pre-heated mould and cured at the conditions listed in Table 1. After curing, a clear plaque was obtained indicating excellent compatibility between the toughener phase and matrix phase. Related thermal and mechanical properties are shown below in Table 1.

### Comparative Examples 1 and 2

Examples 3 and 4 were repeated, except for the addition of the amine-terminated polysulfone. Related thermal and mechanical properties are listed below in Table 1.

TABLE 1
Properties of curable compositions

| | | Comparative | Comparative | Exam- | Exam- |
|---|---|---|---|---|---|
| Curable Composition | | Ex. 1 | Example 2 | ple 3 | ple 4 |
| BPA benzoxazine | | 75 | 70 | 70 | 70 |
| CY179 | | 25 | 30 | 25 | 30 |
| Polysulfone | | | | 10 | 25 |
| Curing conditions | | 180° C. 2 h + 200° C. 2 h + 220° C. 2 h | | | |
| Transparency of cured | | Yes | Yes | Yes | Yes |
| resin | | | | | |
| Tensile Modulus (Gpa) | | 4.5 | 4.2 | 4.4 | 4 |
| Tensile Strength (Mpa) | | 36 | 35 | 58.6 | 64.9 |
| Elongation % | | 0.76 | 0.9 | 1.42 | 1.76 |
| Flexural Modulus (Gpa) | | 4.7 | 4.3 | 4.7 | 4.1 |
| Flexural Strength (Mpa) | | 107 | 80 | 99.6 | 112 |
| Elongation [symbol] % | | 2.1 | 1.7 | 2 | 2.5 |
| K1C (Mpa M^{0.5}) | | 0.58 | 0.53 | 0.82 | 0.99 |
| G1C (J/m²) | | 91 | 77 | 162 | 218 |
| T_{g} by DMA | E′ | 209 | 203 | 207 | 215 |
| (° C.) | E″ | 226 | 221 | 219 | 227 |
| | Tan Delta | 240 | 243 | 234 | 241 |

As shown in Table 1, addition of the polysulfone toughener to the curable composition provides a cured article having a significant increase in toughness without affecting the glass transition temperature or tensile/flexural modulus. This is very unusual and was not expected for such high temperature thermoset systems.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

What is claimed is:

1. A curable composition comprising:
(a) a benzoxazine;
(b) a polysulfone-based toughener compound comprising one or more repeating units of the formula (4): 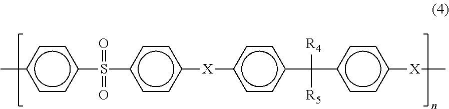
where n=1 to 2 and can be fractional;
X is O or S and may differ from unit to unit; and
R₄ and R₅ are independently H, a C₁ to C₈ alkyl group or are fused together; and optionally
(c) an epoxy resin.

2. The curable composition of claim 1, wherein the benzoxazine is a compound of the formula 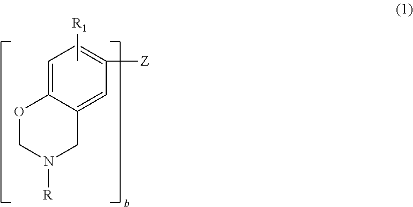
where b is an integer from 1 to 4; each R is independently hydrogen, a substituted or unsubstituted C₁-C₂₀ alkyl group, a substituted or unsubstituted C₂-C₂₀ alkenyl group, a substituted or unsubstituted C₆-C₂₀ aryl group, a substituted or unsubstituted C₂-C₂₀ heteroaryl group, a substituted or unsubstituted C₄-C₂₀ carbocyclic group, a substituted or unsubstituted C₂-C₂₀ heterocyclic group, or a C₃-C₈ cycloalkyl group; each R₁ is independently hydrogen, a C₁-C₂₀ alkyl group, a C₂-C₂₀ alkenyl group, or a C₆-C₂₀ aryl group; and Z is a direct bond (when b=2), a substituted or unsubstituted C₁-C₂₀ alkyl group, a substituted or unsubstituted C₆-C₂₀ aryl group, a substituted or unsubstituted C₂-C₂₀ heteroaryl group, O, S, S═O, O═S═O or C═O.

3. The curable composition of claim 2 wherein the benzoxazine is a compound of the formula: 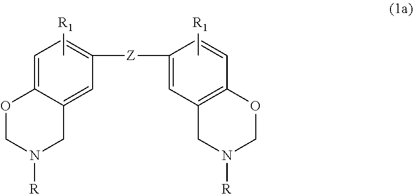
where Z is selected from a direct bond, CH₂, C(CH₃)₂, C═O, O, S, S═O, O═S═O and 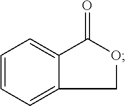
each R is independently hydrogen, a C₁-C₂₀ alkyl group, an allyl group, or a C₆-C₁₄ aryl group; and R₁ is independently hydrogen, a C₁-C₂₀ alkyl group, a C₂-C₂₀ alkenyl group, or a C₆-C₂₀ aryl group.

4. The curable composition of claim 1 wherein the benzoxazine is a compound of the formula 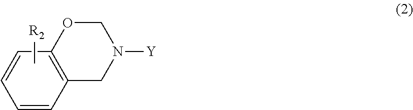
where Y is a C₁-C₂₀ alkyl group, a C₂-C₂₀ alkenyl group, or substituted or unsubstituted phenyl; and each R₂ is independently hydrogen, halogen, a C₁-C₂₀ alkyl group, or a C₂-C₂₀ alkenyl group.

5. The curable composition of claim 1 wherein the benzoxazine is a compound of the formula 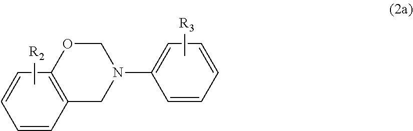
where each R₂ is independently a C₁-C₂₀ alkyl or C₂-C₂₀ alkenyl group, each of which being optionally substituted or interrupted by one or more O, N, S, C═O, COO and NHC═O, and a C₆-C₂₀ aryl group; and each R₃ is independently hydrogen, a C₁-C₂₀ alkyl or C₂-C₂₀ alkenyl group, each of which being optionally substituted or interrupted by one or more O, N, S, C═O, COOH and NHC═O or a C₆-C₂₀ aryl group.

6. The curable composition of claim 1, wherein the polysulfone-based toughener compound further comprises one or more reactive end groups.

7. The curable composition of claim 5, wherein the reactive end groups are selected from —OH, —COOH, —NH₂, —NHR^{k} where R^{k} is a hydrocarbon group containing up to eight carbon atoms, —SH, benzoxazine, epoxy, (meth)acrylate, cyanate, isocyanate, acetylene, ethylene, maleimide, and anhydride.

8. The curable composition of claim 1, wherein the polysulfone-based toughener compound further comprises one or more other repeating units selected from:
—X—Ar—SO₂—Ar—X—Ar—SO₂—Ar—
and
—X—(Ar)ₐ—X—Ar—SO₂—Ar—
where X is O or S and may differ from unit to unit;
Ar is phenylene; and
a=1 to 3 and can be fractional and wherein when a is greater than 1, the phenylene groups are linked linearly through a single chemical bond.

9. The curable composition of claim 1 wherein an epoxy resin is present and is selected from a polyglycidyl epoxy compound; a non-glycidyl epoxy compound; an epoxy cresol novolac compound; an epoxy phenol novolac compound and mixtures thereof.

10. A method of making a curable composition comprising mixing together from about 10-90% by weight of a benzoxazine and from about 2-50% by weight of a polysulfone-based toughener compound comprising one or more repeating units of the formula (4): 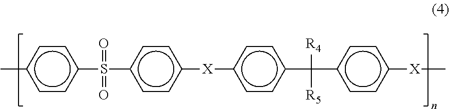
where n=1 to 2 and can be fractional;
X is O or S and may differ from unit to unit, and
R₄ and R₅ are independently H, a C₁ to C₈ alkyl group or are fused together; and optionally
(c) about 10% to 70% by weight of an epoxy resin
wherein the percent by weights are based on the total weight of the curable composition.

11. Use of the curable composition of claim 1 as an adhesive, sealant, coating or encapsulating system for an electronic or electrical component.

12. A cured article comprising bundles or layers of fibers infused with the curable composition of claim 1.

13. A method for producing a composite article in a resin transfer molding system comprising the steps of: a) introducing a fiber preform comprising reinforcement fibers into a mould; b) injecting the curable composition of claim 1 into the mould, c) allowing the curable composition to impregnate the fiber preform; and d) heating the resin impregnated preform at a temperature of least about 90° C. for a sufficient period of time to produce an at least partially cured solid article; and e) optionally subjecting the partially cured solid article to post curing operations to produce the composite article.

14. A method for producing a composite article in a vacuum assisted resin transfer molding system comprising the steps of a) introducing a fiber preform comprising reinforcement fibers into a mould; b) injecting the curable composition of claim 1 into the mold; c) reducing the pressure within the mold; d) maintaining the mold at about the reduced pressure; e) allowing the curable composition to impregnate the fiber preform; and f) heating the resin impregnated preform at a temperature of at least about 90° C. for a sufficient period of time to produce an at least partially cured solid article; and e) optionally subjecting the at least partially cured solid article to post curing operations to produce the flame retarded composite article.
